(19) United States
(12) Patent Application Publication
(10) Pub. No.: US 2007/0022659 A1
(43) Pub. Date: Feb. 1, 2007

(54) Rooting Container Transfer Device

(76) Inventor: Robert Amil Kleinert, (US)

Correspondence Address: JOAN L. SIMUNIC, P.O. BOX 443, LA GRANGE, KY, 40031-0443, US

(21) Appl. No.: 11/532,902

(22) Filed: Sep. 18, 2006

Related U.S. Application Data
(63) Continuation-in-part of application No. 10/639,069, filed on Aug. 12, 2003.
(60) Provisional application No. 60/402,615, filed on Aug. 12, 2002.
(60) Provisional application No. 60/469,886, filed on May 13, 2003.

(51) Int. Cl. A01G 23/02

(52) U.S. Cl. 47/73

(57) ABSTRACT

The present development is a device for lifting and transporting heavy and/or awkward containers. The device comprises a clamping unit having a jaw for engaging the container.

### CROSS-REFERENCE TO PRIOR APPLICATIONS

The present application claims priority to U.S. provisional patent application 60/402,615 filed Aug. 12, 2002 and to U.S. provisional patent application 60/469,886 filed May 13, 2003, and to U.S. patent application Ser. No. 10/639,069 filed Aug. 12, 2003, all of which are incorporated herein by reference.

### BACKGROUND

The present development is a device that facilitates the removal of rooting containers from the ground, and that eases transportation of the containers. The device includes a clamping unit that reversibly secures the container during a lifting stage. The clamping unit may be affixed to a handle or to a cart.

Commercial growers commonly use pot-in-pot containers or grow bags (“rooting containers”) when promoting early growth of saplings, young shrubs, or similar plants with the intent of transplanting the plants when they reach a predetermined size. In a commercial nursery, the containers—filled with soil and the plant−are usually positioned within a grid having a plurality of parallel rows. To maximize production, the rows are separated by a nominal distance that allows the grower to move between the rows for watering and maintaining the plants. When a plant reaches an acceptable size for transplanting, the container or bag is removed from its position within the grid and transferred to market.

In general, the pot-in-pot containers are used for relatively large plants, such as those requiring a pot ranging in size from about 5 gallons to about 30 gallons. When filled with soil and the growing plant, these containers can range in weight from about 25 pounds to about 300 pounds. This can create challenges for the grower when it is time to remove the plant from the growth grid. For the plants positioned along the outer edges of the grid, heavy motorized equipment can be used to lift and transfer the containers. However, for the plants positioned within the interior rows, the relatively narrow spacing between the rows can make it impossible for the heavy equipment to get close enough to the plants for removal without risk of damaging surrounding plants. In these cases, it is not uncommon for two or more persons to manually hoist the container from the ground and drag it to a more accessible position near the exterior rows. Because the containers can be awkward to handle, there is a constant risk of damage to the plant and/or injury, such as back or muscle sprains, to the persons moving the containers.

### SUMMARY OF THE PRESENT INVENTION

The present development is a rooting container transfer device that facilitates the removal of the rooting container from the ground. The transfer device includes a clamping unit comprising retractable toothed jaws that can be used to reversibly grasp an upper edge of the container. The clamping unit is affixed to a handle which may be further attached or used in combination with a wheeled cart.

The toothed jaws ensure that the user has a firm grip on the rooting container thereby minimizing the risk of the container slipping from the user during lifting and/or transport. The handle provides leverage to the user thereby facilitating the lifting and carrying of the rooting container. The combination reduces the strain of lifting and carrying the rooting container for the user. Further, because the clamping unit can be affixed to a small hand-held handle, the user can use the rooting container transfer device within closely spaced growing rows.

In an alternative embodiment, the clamping unit may be affixed to a wheeled cart, which may be motorized if desired. The cart, while requiring more spacing between growing rows, allows a single user to lift and transfer relatively large rooting containers.

### BRIEF DESCRIPTION OF THE FIGURES

FIG. 1A is a view of a rooting container transfer device made according to the present invention and having a hand-held handle as used to grasp a rooting container;

FIG. 1B is a view of a rooting container transfer device made according to the present invention and having a handle affixed to a cart as used to grasp a rooting container;

FIG. 2 is a perspective view of the rooting container transfer device of FIG. 1A;

FIG. 3 is a side view of the device of FIG. 2 with the handle removed; and,

FIG. 4 is a perspective view of the rooting container transfer device of FIG. 1A.

### DETAILED DESCRIPTION OF THE INVENTION

The present development is a rooting container transfer device. The device is intended to be used for the lifting and transport of pot-in-pot containers or grow bags. Specific dimensions relevant to the rooting container transfer device components are provided herein for the purpose of demonstrating the invention, but these dimensions are not intended to limit the scope of the invention. The dimensions are based on the assumption that the rooting container transfer device would be used to lift and/or transport standard commercially available pot-in-pot containers or grow bags having volumes of from about 5 gallons to about 30 gallons, but it is anticipated that the device could be used with containers having different dimensions and the device dimensions may be adjusted accordingly. Further, the device may be used to move any heavy or awkward container, such as feed tubs, in addition to pot-in-pot containers.

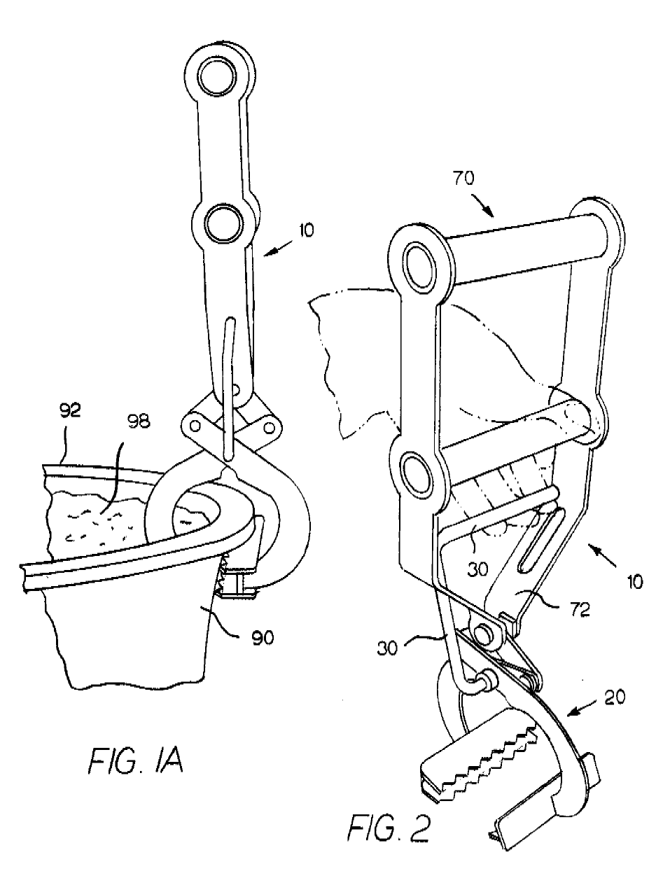

FIGS. 1A and 1B show a first and a second embodiment of the rooting container transfer device 10, 110, respectively. Referring to FIG. 1A, shown as used to engage a rooting container 90, the device 10 has a clamping unit 20 designed to grasp a top edge 92 of the container 90. The container 90 is typically filled with soil 98 and a young plant 96. With the rooting container transfer device 10 grasping the container 90, the container 90 can be lifted and moved. In the embodiment shown in FIG. 1B, a pair of clamping units 120 is affixed to a wheeled cart 60. The clamping units 20 are controlled remotely thereby allowing a single user to operate the units 20 in tandem to grasp, lift and move the container 90.

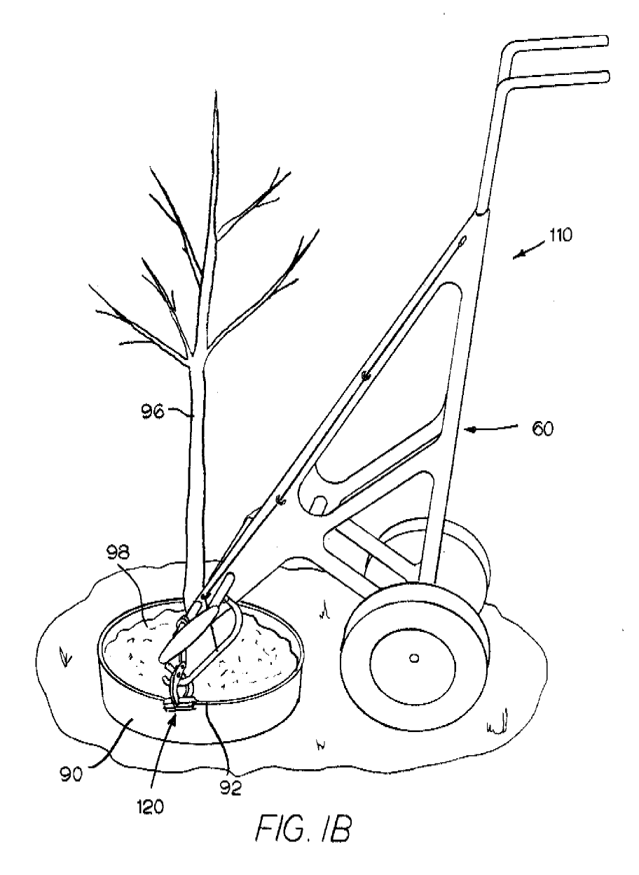

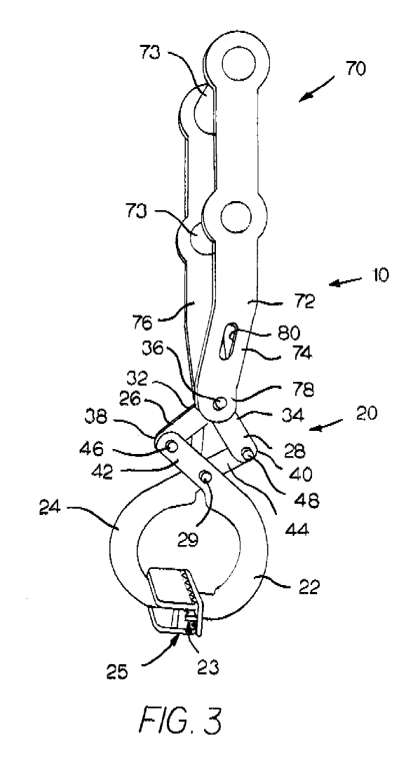

As shown in FIGS. 2 and 3, the first embodiment of the rooting container transfer device 10 has the clamping unit 20 affixed to a handle 70. The clamping unit 20 comprises a mounting frame 72, a pair of compression flanges 26, 28, a pair of retractable jaws 22, 24 and a lifting rod 30. The mounting frame 72 comprises a pair of sides 74, 76 and defines a base attachment point 78. The frame 72 further includes at least one aperture 80 of dimensions adequate to allow the lifting rod 30 to operate.

The flanges 26, 28 define first 32, 34 and second 38, 40 ends. The first ends 32, 34 are secured to each other and to the frame attachment point 78 with a pin, brad, bolt or other means 36 that will allow each flange to move relative to the other.

The combination of the mounting frame 72, the pair of compression flanges 26, 28, the pair of retractable jaws 22, 24 and the securing means 36 may also be referred to as a “lazy tong” structure. In the rooting container transfer device of the present development, there is a single “lazy tong” structure per pair of retractable jaws.

Each jaw 22, 24 has a set of teeth 23, 25 at one end and a tail 42, 44 at the opposing end. The teeth 23, 25 are secured to the jaws 22, 24 such that the midpoint of the first toothed section 23 is secured to the first retractable jaw 22 and the midpoint of the second toothed section 25 is secured to the second retractable jaw 24. The tail end 42 of the first jaw 22 is secured to the second end 38 of the first flange 26 with a pin, brad, bolt or other means 46 that will allow the jaw 22 to move relative to the flange 26. Similarly, the tail end 44 of the second jaw 24 is secured to the second end 40 of the second flange 28 with a pin, brad, bolt or other means 48 that will allow the jaw 24 to move relative to the flange 28.

With the teeth 23, 25 of the jaws in a closed position, the jaws 22, 24 cross at a predetermined position 29 between the teeth 23, 25 and the tail ends 42, 44. The lifting rod 30 projects through the jaws at the cross position 29 and then is bent to project through the aperture 80. When the rod 30 is pulled upward toward the frame attachment point 78 the opposing ends 38, 40 of the flanges 26, 28 are forced apart pulling the jaws 22, 24 open. Releasing the lift rod 30 allows gravity to pull the rod 30 away from the attachment point 78 and forces the jaws 22, 24 to close. Optionally, the rod 30 can have any configuration that will allow the user to manipulate the rod 30 to open the jaws 22, 24. In a preferred embodiment the lift rod 30 is bent after passing through the aperture 80 to lie essentially parallel to the teeth 23, 25 allowing the user to easily grasp and pull the rod 30.

The teeth 23, 25 of the clamping unit 20 may vary in design depending on the intended application. For example, the teeth may be complementary, i.e. when the two sets of teeth 23, 25 abut they appear to form a single unit. Optionally, for better grasping of plastic pot-in-pot containers, the teeth may be staggered such that when the jaws are closed, the teeth 23, 25 are not in direct contact with each other. In the embodiment of FIG. 3, the first set of teeth 32 comprises a double row whereas the second set of teeth 34 comprises a single row that fits between the rows of the first set of teeth 32 in the closed position. Optionally, the teeth may be cut in a variety of sizes and dimensions. For example, the teeth may be essentially smooth and even as with a standard saw-tooth pattern, or they may be cut in an irregular pattern, including patterns to match container configurations as might occur such as to accommodate ribs on the container, or they may form essentially smooth or flat surfaces, or they may define a series of locking grooves.

The handle 70 provides a means for carrying the clamping unit 20 and provides additional leverage for the user when the device 10 is in use. The handle 70 comprises at least one rung 73 fixedly attached to the mounting frame 74. In the embodiment of FIGS. 1A, 2 and 3, the handle 70 includes a pair of parallel rungs 73.

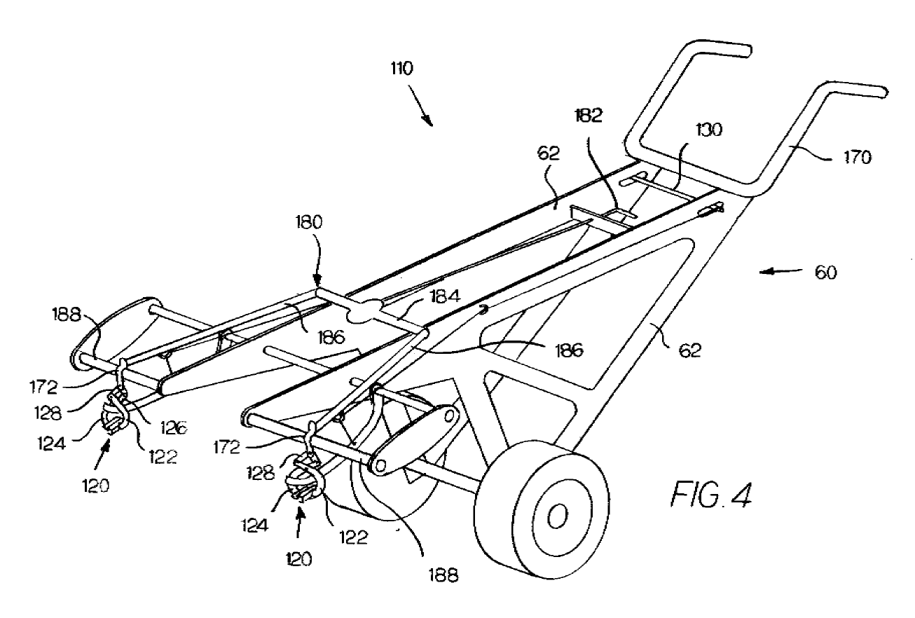

FIGS. 1B and 4 show an alternative embodiment of a rooting container transfer device 110. In this embodiment, the clamping unit 120 is attached to a wheeled cart 60 and the jaws 122, 124 can be operated remotely and in unison. The cart 60 is preferably sized to allow a single operator to push the cart 60. The cart 60 has a support frame 62 with a plurality of braces to add strength. At an upper end of the support frame 62 is a handle 170. As shown in FIGS. 1B and 4, the handle 170 is fixedly attached to the frame 62. Optionally, the handle 170 may be secured to the frame 62 in a manner that would provide for the handle to be folded over flush with the frame 62 for easier storage or to allow the user greater handling flexibility. The frame 62 further provides that when the pot-in-pot container 90 is lifted, the container 90 is cradled under the frame 62 rather than being supported underneath.

Similar to the embodiment 10 of FIGS. 1A, 2 and 3, the clamping unit 120 of the present embodiment 110 includes a mounting frame 172, a pair of compression flanges 126, 128, a pair of retractable jaws 122, 124, and a lifting rod 130. When the lifting rod 130 is pulled toward the handle 170, the jaws 122, 124 open allowing the clamping unit 120 to engage the container. As shown in the embodiment 110 of FIGS. 1B and 4, a single lifting rod 130 simultaneously controls the actions of two clamping units 120. Alternatively, separate lifting rods could be provided for each clamping unit although it is anticipated that this would require a more skilled operator.

The embodiment 110 differs from the embodiment 10 by further including a spacing adjuster 180. The spacing adjuster 180 allows the user to move the clamping units 120 relative to each other to accommodate different sized containers. The spacing adjuster 180 comprises a control lever 182 attached to a guide bar 184. The guide bar 184 is further connected to a pair of adjuster rods 186, and each adjuster rod 186 is secured to the mounting frame 172 of its respective clamping unit 120. Each mounting frame 172 is mounted on a spacer bar 188 in a manner that allows the frame 172 to glide horizontally along the bar 188, and that further allows the frame 172 to alter its vertical orientation so that as the container 90 is lifted the plant 96 is held essentially erect. As the user pulls the control lever 182 toward the handle 170, the guide bar 184 moves toward the handle pulling the adjuster rods 186 to a more vertical position relative to the spacer bar 188, and forcing the mounting frames 172 to move closer to each other, thereby allowing the user to position the clamping units 120 to grasp a relatively small container. If the user pushes the control lever 182 away from the handle 170, the guide bar 184 moves away from the handle 170, the adjuster rods 186 are forced away from the vertical position, and the clamping units 120 are forced apart by the mounting frames 172 allowing the user grasp a larger container. Optionally, the spacing adjuster 180 may further include a slide lock or similar mechanism for locking the control lever 182 at a specified position thereby allowing the user to set the spacing on the clamping units 120 without having to continually hold the control lever 182.

The embodiment 110 may further be mechanized (not shown) with a self-propelling motor or by being attached to an exterior power source, such as a skid steer loader. In a mechanized device 110, electric or hydraulic systems may be used to control the jaws 122, 124, the spacing adjuster 180, or other components of the rooting container transfer device.

It is understood that one skilled in the art may make alterations to the embodiments shown and described herein without departing from the scope of the invention. For example, it is anticipated that a variety of tooth shapes, including varying the number of interlocking plates, would function as intended. Further, the specific cart designs may vary with respect to bracing and frame structural supports from those depicted in the figures without departing from the scope of the invention. For example, the cart handle may be adapted to accommodate a rod for increasing the lifting leverage, or the cart may be adapted to allow the cart to be pulled by a motorized vehicle.

What is claimed is:

1. A rooting container transfer device comprising:
a. a clamping unit comprising a lifting rod secured to a single lazy tong at a predetermined position, said single lazy tong comprising a first retractable jaw and a second retractable jaw, and each of said first and second retractable jaws having a second end secured to a flange, and each of said flanges having an opposing end secured to each said opposing end of said flanges and to a mounting frame, wherein said rod, jaws, flanges and frame are interconnected such that said jaws can be caused to open by movement of said rod, and wherein said first retractable jaw has a curved section terminating in a first toothed end, and said second retractable jaw has a curved section terminating in a second toothed end, wherein said first jaw and said second jaw are each aligned such that the first toothed end and the second toothed end abut when in a closed position, and wherein said first toothed end is positioned on said first retractable jaw at about a midpoint of said first toothed end and wherein said second toothed end is positioned on said second retractable jaw at about a midpoint of said second toothed end; and
b. a handle, fixedly attached to said mounting frame and providing access to said rod.

2. The container transfer device of claim 1 wherein said jaws have teeth that are complementary.

3. The container transfer device of claim 1 wherein said jaws have teeth that are irregular.

4. The container transfer device of claim 1 wherein a first jaw has a double row of teeth and a second jaw has a single row of teeth.

5. The container transfer device of claim 1 wherein a first jaw has a double row of teeth and a second jaw has a double row of teeth, and the rows interlock when the jaws are in a closed position.

6. The container transfer device of claim 1 wherein said handle further comprising at least one rung.

7. The container transfer device of claim 1 further comprising a cart wherein said mounting frame is secured to said cart.

8. The container transfer device of claim 7 wherein said cart comprises a support frame, wheels and a handle.

9. The container transfer device of claim 7 wherein said cart further includes a spacing adjuster comprising a control lever attached to a guide bar, and said guide bar being further connected to a pair of adjuster rods, and each said adjuster rod being secured to said mounting frame of the respective clamping unit.

10. The container transfer device of claim 8 wherein said handle is retractable.
